(19) United States
(12) Patent Application Publication
(10) Pub. No.: US 2003/0206579 A1
(43) Pub. Date: Nov. 6, 2003

(54) Multistage nonlinear echo-canceller for digital communication systems with or without frequency division duplexing

(76) Inventor: Paul Henry Bryant, Encinitas, CA (US)

Correspondence Address: Terrance A. Meador, INCAPLAW, 1050 Rosecrans Street, Suite K, San Diego, CA, 92106, US

(21) Appl. No.: 10/456,270

(22) Filed: Jun. 6, 2003

Related U.S. Application Data
(63) Continuation-in-part of application No. 09/968,469, filed on Oct. 1, 2001.
(63) Continuation-in-part of application No. 09/968,063, filed on Oct. 1, 2001.
(60) Provisional application No. 60/422,655, filed on Oct. 30, 2002.

(51) Int. Cl. H04B 1/38; H04L 5/16; H04B 3/20

(52) U.S. Cl. 375/219; 370/286; 379/406.01

(57) ABSTRACT

In a digital communication system where digitally modulated signals are transmitted in a signal path including a bi-directional channel, a multistage echo-canceller has two or more stages connected in a sequence to remove the linear and nonlinear echo of the outgoing signal from the incoming signal. Results are of importance both to systems with overlapping outgoing and incoming frequency bands and to those with separated bands (for which only the nonlinear echo is of concern). The two or more stages are each characterized by a respective function, and the sequence is characterized by alternation of the functions of the two or more stages between linear and nonlinear.

### CROSS REFERENCE TO RELATED APPLICATIONS

This application claims priority to U.S. Provisional Application No. 60/422,655 filed Oct. 30, 2002. This application also claims priority as a continuation-in-part of the following pending U.S. patent applications, both of which are incorporated by reference: Ser. No. 09/968,469, filed Oct. 1, 2001 for “Peak-to-Average Power Ratio Reduction in a Digitally Modulated Signal”; and Ser. No. 09/968,063, filed Oct. 1, 2001 for “A Multistage Equalizer that Corrects for Linear and Nonlinear Distortion in a Digitally Modulated Signal”.

### BACKGROUND OF THE INVENTION

The invention concerns the transmission of information by digitally-modulated means over a bi-directional channel in the presence of linear and non-linear distortion. More particularly, the invention concerns the correction of received digitally-modulated signals for the effects of reflections or echoes of transmitted signals especially when the echoes are subject to both linear and non-linear distortion.

Digital modulation refers to the use of digital codes to vary one or more characteristics of one or more carriers in a way that plants information into the variation. In this regard, a modulated carrier “carries” the information. An unmodulated carrier may have zero frequency, that is, it may have a constant level such as voltage, or it may be time-varying, like a sine wave. The variation produced by digital modulation may be in one or more of the amplitude, phase, and frequency of a carrier. The purpose of digital modulation is to have information transmitted via the modulated signal or signals in, for example, a communication channel or a data storage channel.

For clarity, “transmission” of digitally modulated signals refers to their passage through a signal path that includes a channel plus any other elements at either end of the channel through which the signals must pass in order to be placed in or received from the channel. The term “channel” means a physical medium used to conduct or store signals. Examples of channels include twisted pairs of wires, coaxial cables, optical fibers, electromagnetic waves in space, and so on. In addition to a channel, a signal path includes components or elements that are coupled to either end of a channel in order to feed digitally-modulated signals into the channel or to receive them from the channel.

Transmission of digitally-modulated signals in a system designed for digital communication or data storage often assails those signals with linear distortion and nonlinear distortion. Such distortion degrades the signals and requires corrective measures when the signals are received in order that information can be reliably extracted from the signals.

Linear distortion changes the shapes of signals as they are transmitted. In this regard, a channel through which the signals are transmitted disperses the amplitudes and phases of the components of the signals to unequal degrees that are dependent upon the frequencies of the components. The result is smearing in the received signals, which can lead to intersymbol interference. Such a channel is denominated a “dispersive channel”. A channel in which the output changes in direct proportion to changes made in the input signal or some component thereof may be considered a “linear channel”. However in such a channel the components of different frequencies may travel through the channel at different speeds and be attenuated by different factors. These effects of linear distortion can be ameliorated by equalization of received signals. A linear equalizer removes or reduces the effects of linear distortion by making adjustments in the components of a received signal to compensate for the changes made in those components by transmission through the channel. Linear effects do not create new frequencies that were not part of the undistorted signal.

Nonlinear distortion occurs when the proportionality or linearity with which a signal is being distorted is violated to some degree. Typically such nonlinear effects are not distributed throughout the signal path, but rather are concentrated at particular sites. Some examples of nonlinear distortion include: (1) a driver at the input to a channel or a mid-channel repeater that exhibits some nonlinearity dependant on the signal amplitude or on the derivative of the amplitude (slew rate); (2) a corroded contact in a channel that has some nonlinear (non-ohmic) characteristics; (3) a transformer in a channel that exhibits some significant nonlinearity, perhaps related to magnetic hysteresis in its core. Nonlinear effects usually result in the generation of new frequencies that were not part of the original undistorted signal.

A single channel may provide oppositely-directed transmission for two signal paths. Two-way transmission through a single, shared channel requires means in the channel for separating outgoing from incoming signals at each end of the channel; it may also require repeater means in the channel capable of separating and then recombining oppositely-directed signals intermediate the ends of the channel.

The separation process is not a perfect one and as a result some of the signal transmitted at one end of a channel may be reflected back or “echoed”. The echo combines with the incoming signal and can be considered as though it was noise. For some communications systems the incoming and outgoing signals share all or part of the same frequency band. In these cases a linear echo canceller is often used to reduce the level of the echo. It does this by modeling the effects of various system components and the channel on the echo signal so as to create a prediction of the expected echo signal. This is subtracted from the incoming signal to greatly reduce the echo and thus improve the signal to noise ratio. Other systems have separate bands for the two directions. This is known as frequency division duplexing or FDD. The linear part of the echo of one of the signals will remain in the appropriate band, but this is not true for the nonlinear echo, which will often contain new frequency components that can extend far outside of this band and may overlap the opposing band. Thus, a multistage nonlinear echo canceller, the subject of this specification, can be of benefit to both FDD and non-FDD systems.

In some cases the signal to be transmitted can contain low level out of band components. For example, there could be undesired effects from the finite sampling rate used, or glitches in the data at transitions between one data symbol and the next one. These components can be removed either by careful filtering of the signal before transmission, or else their effects can be corrected later by linear echo cancellation. If all out of band components are removed prior to transmission, then a linear echo canceller has no value in an FDD system.

Some solutions to the echo cancellation problem do consider the need for nonlinear as well as linear echo cancellation. For example, U.S. Pat. No. 5,627,885 entitled considers separate linear and nonlinear echo cancellers; however, these echo cancellers are connected in parallel rather than in series.

### SUMMARY OF THE INVENTION

The invention, a multistage nonlinear echo canceller (MNEC), provides an effective solution to the problem of correcting signals to remove the effects of linear and nonlinear echo, especially where the nonlinear distortion of the echo signal is imposed at one or more locations in an otherwise linear signal path. The location and characteristics of the nonlinear effect(s) need not need be known in advance, as the MNEC has adjustable parameters which allow it to adapt to a continuum of different situations. The MNEC includes a plurality of stages. Each stage is characterized by a function that models a distortion in an echo of a transmitted signal. The stages are connected in a sequence in which the function of the stages alternates between linear and nonlinear, with two or more stages in the sequence. One or more linear stages are provided to remove linear distortion imposed on the echo signal in one or more sections of the signal path in which no significant nonlinear effects are present. One or more nonlinear stages are provided to correct distortion caused by localized nonlinear effects. To the extent that nonlinear distortion is localized, it can be more accurately modeled and corrected by a nonlinear stage characterized by a function with a relatively small number of adjustable parameters.

In the case where there is a single primary source of nonlinear distortion located somewhere in the echo signal path, the preferred embodiment of the multistage equalizer has three stages in the sequence linear, nonlinear, linear. In this case the MNEC includes a first, linear stage characterized by a function that operates directly on a copy of the signal that is being transmitted to produce first results modeling linear distortion which occurs in the portion of the echo signal path between the beginning and location of the source of nonlinear distortion. This linear distortion might for example originate in some filtering that is done to the signal to reduce out of band components before transmission. The MNEC further includes a second, nonlinear stage coupled to the first stage and characterized by a second function that operates on the first results to produce second results modeling nonlinear distortion produced by the source of nonlinear distortion. Such nonlinear distortion might for example originate in the digital to analog converter, in the line driver, in the line coupling transformer, a corroded connection in the line, or some combination of these components. A third, linear stage, which is coupled to the second stage, is characterized by a third function that operates on the second results to produce third results modeling linear distortion in the portion of the signal path between the location of the source of nonlinear distortion and the end of the echo signal path. This linear distortion might for example originate in impedance mismatch between the hybrid circuit and the line, gauge changes in the line, bridged taps attached to the line, bad splices in the line, a filter on the receiver input to reduce out of band components, or a combination of these. The third results are the output of the MNEC. As with a conventional echo canceller, the output is subtracted from the received signal to cancel all or part of the echo. This structure of the MNEC can easily be generalized to cases in which there is more than one site in the echo signal path where nonlinear distortion occurs. Such cases can result in more than three stages for the multistage equalizer. It is most likely, in these cases, that the first and last stages will both be linear; the exception occurs when a nonlinearity is located at the exact start or end of the echo signal path, in which case a linear stage may be omitted.

The functions which characterize the stages may contain adjustable parameters. An echo canceller controller is coupled to the linear and nonlinear stages for setting these parameters to values that minimize a particular error measure. Generally, the adjustment of the function parameters utilizes an optimization process that seeks to minimize the error measure.

### BRIEF DESCRIPTION OF THE DRAWINGS

FIG. 1 shows the frequency bands of a system with frequency division duplexing or FDD. Note that the upstream and downstream bands are separated, while the nonlinear distortion band of the upstream band can significantly overlap the downstream band.

FIG. 2 is a block diagram of elements of one end of a digital communication system that incorporates a multistage nonlinear echo canceller according to the invention.

FIGS. 3a-3b illustrate two respective embodiments of the multistage nonlinear echo canceller (MNEC) of the invention. FIG. 3c illustrates one embodiment of a parallel combination of two echo cancellers. FIG. 3d shows how an MNEC may be combined with a multistage nonlinear equalizer.

FIG. 4 illustrates one embodiment of a linear stage of the multistage nonlinear echo canceller of the invention.

FIGS. 5a-5f illustrate respective embodiments of a non-linear stage of the multistage nonlinear echo canceller.

FIG. 5g illustrates one embodiment of a dual input non-linear stage, which could be used in a combined multistage equalizer and echo canceller as depicted in FIG. 3d.

FIGS. 6a and 6b illustrate, respectively, a Fourier transform and a discrete frequency-domain embodiment of a linear stage.

FIGS. 7a and 7b show for in band and out of band echo respectively, the improvement, using a multistage nonlinear echo canceller according to the invention, in the residual echo of nonlinear distortion products of the transmitted signal.

FIG. 8 shows how a controller is used to optimize the parameters that govern the performance of the multistage nonlinear echo canceller.

FIG. 9 is a generalized flow diagram illustrating an optimization procedure according to the invention for initializing and setting values of parameters in functions that characterize the stages of a multistage nonlinear echo canceller.

### DETAILED DESCRIPTION OF THE PREFERRED EMBODIMENTS

The invention is illustrated in one or more of the above-described drawings, and is disclosed in detail in the following description. Although these illustrations and the description may show and describe elements that are “connected”, this is done in order to establish a sequence with respect to those elements, and to set up a basis for discussion of how those elements act cooperatively. Accordingly, it is within the scope of the invention to place other elements not illustrated or described herein in the connections between elements that are illustrated and described. The invention applies to digital communications over a bi-directional communications channel. The channel may be embodied in any one of a plurality of media.

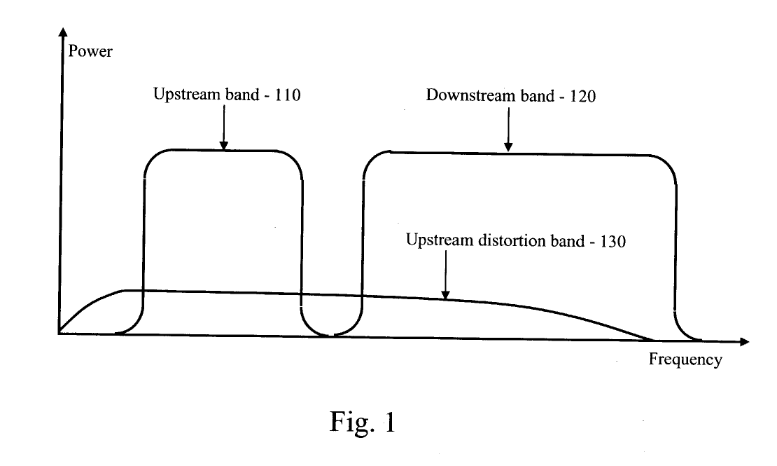

Unlike a conventional echo canceller, a multistage nonlinear echo canceller (MNEC) according to this invention can also be used in cases where the upstream and downstream data occupy separated frequency bands, a process known as frequency division duplexing or FDD. In FIG. 1 we show such separated upstream (110) and downstream (120). Through the process of nonlinear distortion, the upstream signal can generate distortion products that lie in a band (130) that is wider than the upstream band and may overlap the downstream band. Similarly the downstream signal can generate a band of distortion products that may overlap the upstream band (not shown). Any echo of these distortion products will interfere with the true signal in that band and reduce the maximum data rate. The amount of loss is related to the how much the distortion products raise the effective “noise floor” above the background level that is present with no signal applied to the line. The function of the MNEC is to simulate both the distortion and echo processes and create a model of the interference signal, which is then subtracted from the incoming signal to remove these undesirable components and thereby increase the maximum data rate. In cases where the upstream and downstream bands do overlap (i.e., no FDD) the MNEC performs the dual function of replacing the standard linear echo canceller as well as attempting to remove the nonlinear distortion products of the echo signal.

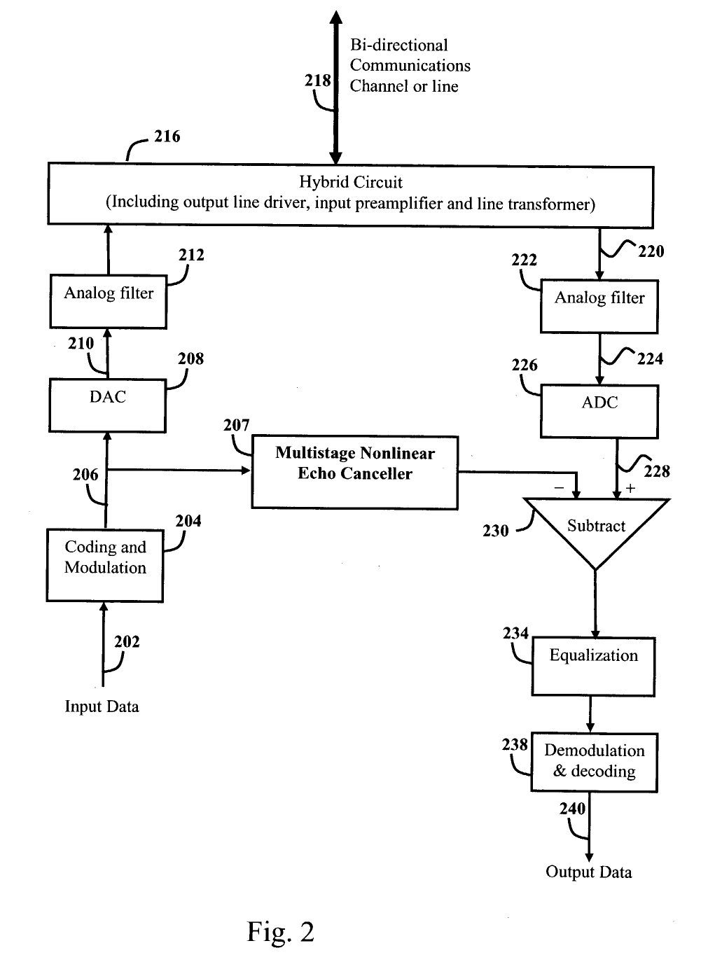

Refer to FIG. 2, which is a block diagram of one end of a digital communication system wherein input data 202 to be transmitted to a destination is provided to coding and modulation circuitry 204. (Note that the processing of digital information can be done either in hardware or software—this applies to all parts of FIG. 2, except those with reference numbers from 210 through 224 where the signal is in analog form.) The circuitry 204 maps the input data 202 to a digital code. This coded data is broken down into a sequence of symbols. Each symbol represents a certain number of bits of digital data. These symbols are then used to modulate a carrier or set of carriers in one or more of amplitude, frequency, and phase. For every allowed symbol there will be a unique setting for these carrier parameters which will remain fixed for a certain length of time before switching to those representing the next symbol. Digital modulation signals 206 are produced by the circuitry 204. These signals 206 represent, in digital form, modulated carriers that are to be transmitted. The digital modulation signals 206 are provided to a digital-to-analog converter (DAC) 208 and also to the MNEC 207. The DAC 208 converts the digital modulation signals to analog form 210. The signals 210 are coupled from the DAC 208 to an analog filter 212 whose purpose is to reduce the level of out of band components of the signal 210, and may as a side effect cause some phase and amplitude distortion to the in band components. This filtered output is connected to the hybrid circuit 216, which serves to separate the outgoing and incoming signals on the bi-directional communications channel 218. Included in the hybrid circuit 216 (but not explicitly shown) are the output line driver, input preamplifier, line coupling transformer, and other components that may vary with design.

Ideally the hybrid 216 would completely separate transmitted and received signals on the line. Unfortunately this is never the case in practice. The Communications channel 218, through a variety of effects, may echo or reflect back a portion of the outgoing signal and allow it to exit the hybrid 216 as though it was part of the received signal 220. In the case of a twisted pair telephone line, these effects include: impedance mismatch between the hybrid 216 and the line 218, wire gauge changes in the line, bridged taps attached to the line and bad splices in the line. The echo signal will typically have also undergone some nonlinear distortion, which might for example occur in the DAC 208, in part of the hybrid 216 or in a bad connection or splice in the line 218. The resultant presence of nonlinear distortion products in the echo signal is the problem that the MNEC, according to this invention, is intended to correct. The received signal 220 is connected to an analog filter 222 whose purpose is to reduce the strength of out of band components, and may as a side effect cause some phase and amplitude distortion to the in band components. The output of the analog filter 222 is connected to the analog to digital converter (ADC) 226, after which the received signal is in digital form. At this point the output of the MNEC 207 is subtracted 230 from the received signal. According to this invention, the function of the MNEC 207 is to generate a model of the expected echo signal including its distortion products to be subtracted from the incoming signal in order to cancel (or partially cancel) the actual echo contained in it and thereby improve the signal to noise ratio. After subtraction 230 the signal is connected to the equalizer 234 to correct for the effects of the channel on the received signal. Finally, the signal is demodulated and decoded 238 producing the output data 240.

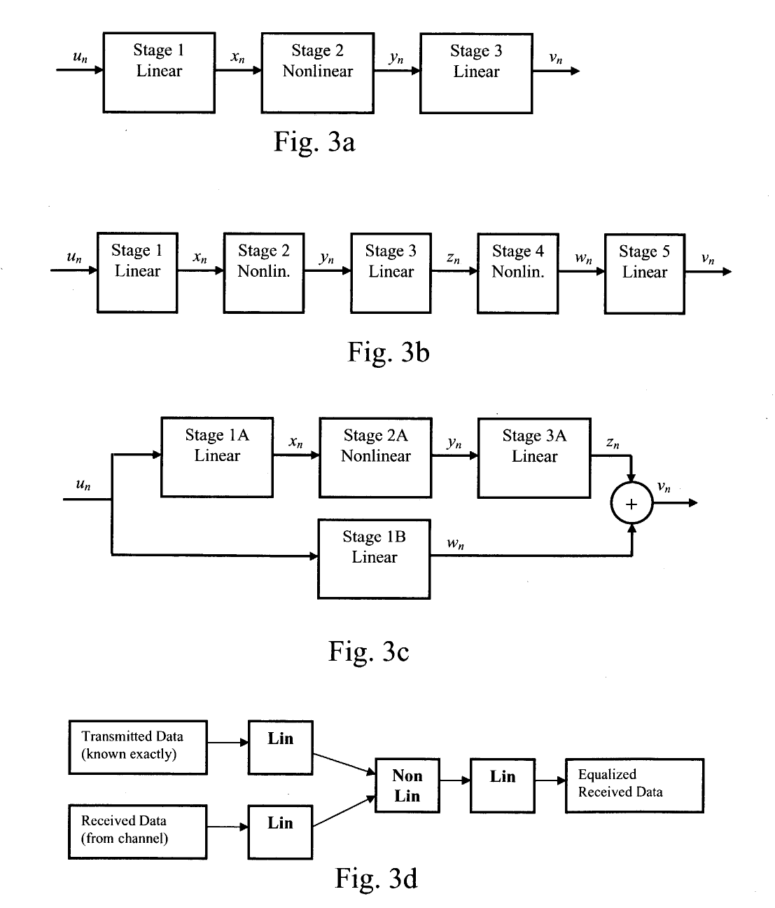

The structure, function, and operation of a multistage nonlinear echo canceller (MNEC) 237 according to this invention may be understood with reference to FIGS. 3a-3d, 4, 5a-f, and 6a-b. The MNEC consists of a sequence of at least two stages. Each stage takes one digital time series x₁, x₂, x₃, . . . as input and produces another one y₁, y₂, y₃, . . . as output. Particular elements of the output series may depend on the values of more than one of the elements of the input series (e.g. yₙ could depend on xₙ₋₂, xₙ₋₁, xₙ, xₙ₊₁, and xₙ₊₂). The stages are characterized by respective functions which may, if desired, depend on a number of settable parameters, not necessarily the same number for each stage. In the following, the stages are, in fact, described in terms of the functions which characterize them, with the understanding that the functions are entirely descriptive of the structures of the stages, as well as their operations. The settable parameters of the characterizing functions enable the MNEC to adapt to a signal path including a channel with unknown or changeable characteristics. The stages are connected in a sequence, so that the input to the MNEC is the input to the first stage, the output of the first stage is connected to the input of the second stage, the output of the second stage is connected to the input of the third stage, and so on until the last stage, the output of which is the output for the MNEC. The stages may be categorized into two types: “linear” and “nonlinear” depending on whether or not an element of the output time series of a stage will always (and for all parameter settings) vary linearly (i.e. in direct proportion) to changes made to an element of the input time series of the stage. The MNEC always conforms to a sequence with at least one linear and one nonlinear stage. Linear stages will typically have output values that depend on many input values, as is necessary to correct for channel dispersion. Nonlinear stages, on the other hand, will typically have output elements that depend only on one or a small number of input elements. The sequence of stages will usually alternate between the two types although this rule could possibly be violated in special cases.

In selecting a particular MNEC architecture, the following guidelines are employed. In producing the echo the signal follows and “echo path” along which it is subject to various sources of linear and nonlinear distortion. Referring again to FIG. 2, this path would extend from the input 206 of the DAC to the output 228 of the ADC. It would include the DAC 208, analog filter 212, the hybrid 216, the channel 218, the analog filter 222 and the ADC 226. In some cases, other devices could also be connected to the channel and could interact with the echo signal (e.g. telephones that share the same twisted pair line with digital communications). For a short channel there could also be some interaction of the echo signal with the modem or other devices attached to the opposite end (not shown) of the channel 218.

The echo path is assumed to contain one or more localized sources of nonlinear distortion. Each nonlinear effect is assumed to act on a one-dimensional (or at least a low dimensional) dynamical variable, such as the amplitude of a signal or its first derivative, at some particular point in the echo path. The design technique underpinning the multi-stage approach is based on the assumption that the echo path can be characterized as a sequence of linear sections separated by these localized nonlinear effects. The details of these effects and their locations do not need to be known in advance. One of these effects will be nearest to the beginning of the echo path. The first step in the echo cancellation process is to recreate the corresponding dynamical variable (or variables) from the (known) signal being transmitted using a linear stage. Then the nonlinear distortion is removed from this dynamical variable (or variables) by a nonlinear stage that follows the linear stage; in many cases this nonlinear stage may be characterized by a power series expansion of a single variable having only a few terms. The output of this nonlinear stage is taken to represent the echo signal just after the nonlinear effect. If there is only one pronounced nonlinear effect in the echo path, this output may be passed on to another linear stage by which the MNEC compensates for additional linear distortion of the echo up to the end of the echo path. Thus, a three-stage structure with the sequence linear, nonlinear, linear shown in FIG. 3a is indicated. Otherwise, additional stages alternating between nonlinear and linear may be added until all nonlinearities have been corrected. FIG. 3b shows a sequence of five stages, which could be used to model an echo path containing nonlinear effects occurring at two different locations. Note that usually the MNEC will begin and end with linear stages. An exception may be made in cases where one of the nonlinear distortion sites is at or near one of the echo path ends, so that there remains no significant linear distortion effects between this site and the end of the echo path.

Since the echoes may occur at more than one site in the system, there will be cases where there is more than one “echo path” that needs to be considered in order to adequately model the behavior. This can be accomplished by placing more than one echo canceller in parallel. These echo cancellers could all be of the sequential MNEC type, or some of them could be linear echo cancellers. A typical example is shown in FIG. 3c, where a three stage MNEC is shown in parallel with a one-stage linear echo canceller. As illustrated, both echo cancellers receive the same input data, while the outputs are added together. It should be noted that the added echo canceller could be placed in parallel with only some of the stages of the MNEC, for example w a linear stage could be deployed in parallel with the last three stages of the MNEC shown in FIG. 3b. More complex architectures are possible, and one in particular that may be useful is depicted in FIG. 3d.

The structure illustrated in FIG. 3d is a multistage device combining the operation of a multistage equalizer with the operation of a multistage nonlinear echo canceller in which two linear stages have respective inputs for receiving transmitted data being input to a channel and received data being coupled from the channel, and respective outputs which are provided to a nonlinear stage having two inputs and at least one output. Such a device may be useful in cases where both the incoming signal (received data) and the echo of the outgoing signal (transmitted data) are interacting with the same source of nonlinear distortion. A typical example might be the nonlinear characteristics of an imperfect splice in a twisted pair line. The outputs of the two linear stages providing respective signals to the two inputs of the nonlinear stage are not necessarily to be added, but rather may act as separate inputs to some nonlinear function by which the nonlinear stage is characterized. This allows for coupling between the outgoing and incoming signals. If such coupling is deemed to be insignificant, then one could, if desired, use both a nonlinear multistage equalizer and an MNEC in their uncoupled forms.

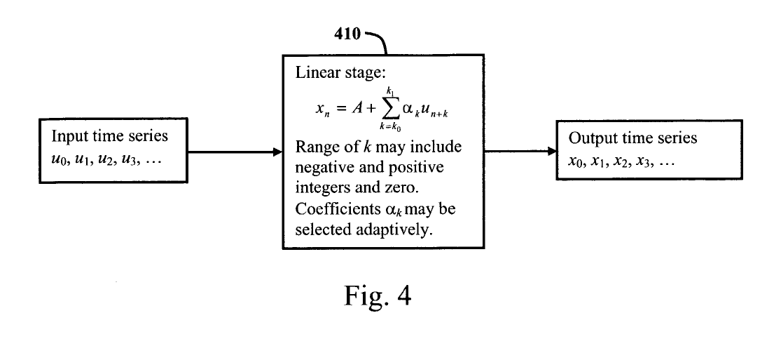

A preferred embodiment of a linear stage is illustrated in FIG. 4. The illustrated linear stage is embodied here as a finite impulse response (FIR) filter. As those skilled in the art will appreciate, such an element may be characterized or described by the function with which it is implemented. In this case, the embodiment is implemented by the function 410, in which:

$${x}_{n} = A + {\sum }_{k = {k}_{0}}^{{k}_{1}} {α}_{k} {u}_{n + k}$$

Using the function 410 shown in FIG. 4 as the first stage of the MNEC depicted in FIG. 3a, the input will be a time sequence of digital values u₀, u₁, u₂, u₃ . . . In the function, each successive digital value is associated with a parameter, in this case, a coefficient αₖ, having a value that is combined (multiplied) with the digital value to yield a product. The range of the index k will typically include all integer values between chosen starting and ending values k₀ and k₁. Note that these values may be positive, negative, or zero. The values used will depend on the dispersion and other characteristics of a particular channel. If needed, a constant parameter A may be included as indicated to correct for shifts in the level of the signal. All of the products are summed and added to A to produce a single member of the output time sequence of digital values x₀, x₁, x₂, x₃. . . . By shifting the association of each parameter to the digital value that is one step forward in the time sequence, the next member of the output sequence is generated and so on. This sequence constitutes the first results produced by the first stage of the MNEC shown in FIG. 3a. The values of the coefficients are set and changed by an echo canceller controller in a manner described later in more detail.

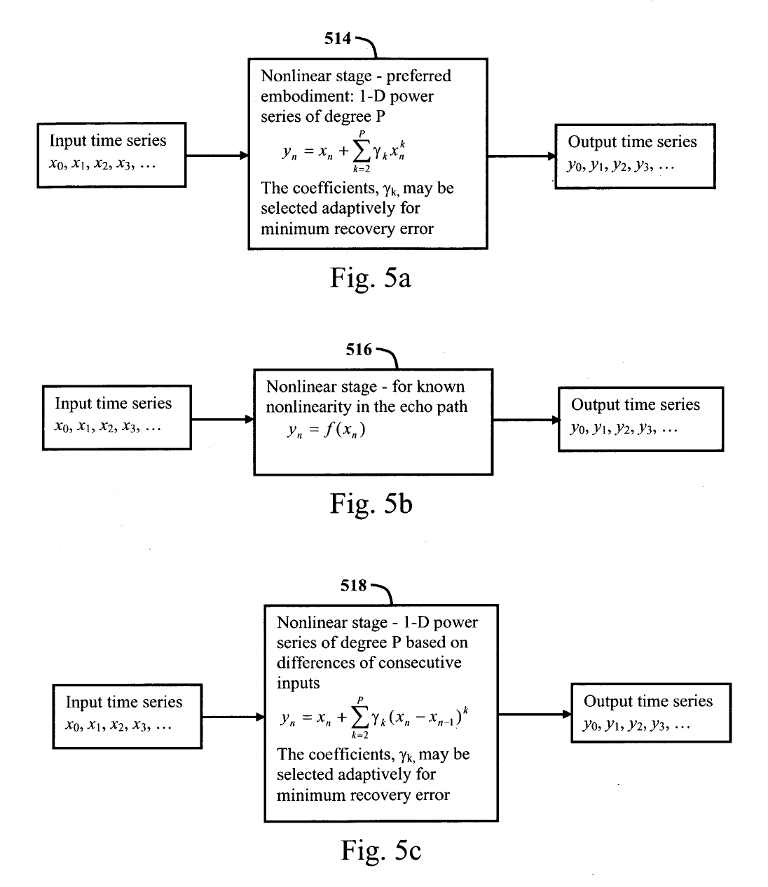

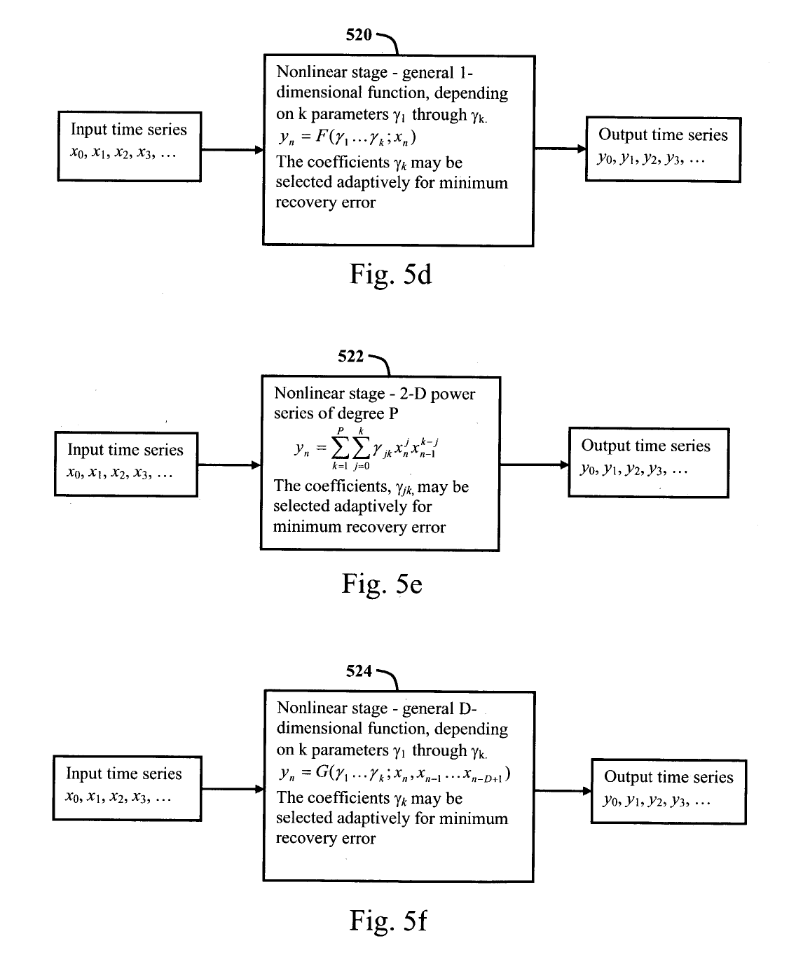

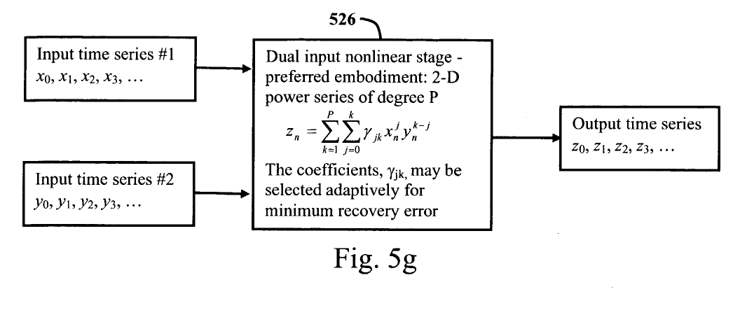

The second stage (now assumed to be nonlinear) of the MNEC of FIG. 3a receives the first results as an input time sequence and produces the second results as an output time sequence y₀, y₁, y₂, y₃. . . . With reference to FIGS. 5a-5g, a plurality of nonlinear stage embodiments may be understood. In FIG. 5a, the nonlinear stage is implemented by a basic power series function 514. This is the preferred embodiment for most cases, especially for amplitude based nonlinearities. This is a one-dimensional (1-D) stage, meaning that the output yₙ depends only on a single input xₙ. Having a low dimensionality makes this stage simple compared to the linear stage (FIG. 4) which in practice will often have a dimension or number of “taps” in the tens or hundreds. The function 516 illustrated in FIG. 5b may characterize the nonlinear stage in the case where the precise form f(x) of the nonlinear function in or near the channel is known and embodied by f(x) which also characterizes the nonlinear stage in this case. FIG. 5c illustrates a difference-based 1-D nonlinear function 518 that may characterize the nonlinear stage. This nonlinear stage embodiment may be selected for use as an alternative to the function 514 for correction of slew-rate related nonlinearities. The nonlinear stage may be implemented according to the general 1-D function 520 illustrated in FIG. 5d, depending on a number of parameters. This case would include other types of series expansions that might have advantages for particular applications and also would include spline or other methods of directly approximating the shape of a nonlinear function. In the nonlinear stage embodiment illustrated in FIG. 5e, the characterizing function 522 may be implemented as a 2-D power series for nonlinearities that cannot be reduced to 1-D such as might depend simultaneously on amplitude and slew rate. This is the most likely embodiment where the function depends on two consecutive input values. The nonlinear stage embodiment of FIG. 5f is characterized by a general function 524 in D-dimensions. The desirability of this embodiment decreases as D increases. 5g illustrates one embodiment of a dual input non-linear stage, such as that depicted in FIG. 3d. The nonlinear function which characterizes the stage may be implemented as a power series that utilizes one element from each of the two input sequences. The ability to correct for upstream/downstream coupling arises from the presence of cross terms in the series that contain both x's and y's to various powers. Manifestly, this can be generalized to an arbitrary D-dimensional nonlinear function that depends on A elements from the first input and B elements from the second, wherein: A+B=D. Since A and B must be at least 1, it follows that D must be at least 2.

As shown by FIG. 3b, additional stages may be added as needed, typically alternating between the linear and nonlinear types.

The parsing of the MNEC into alternating linear and nonlinear stages results in a reduction of the number of adjustable parameters required for modeling of an echo signal. For example, consider a MNEC architecture with three stages in which each of the two linear stages is characterized by a function of 50 input variables (that is where k₀ to k₁ spans 50 values), and in which the nonlinear stage is characterized by a function using a power series of one variable through the 5th power. With an optional constant term included in each of the linear stages, this architecture would require a total of 106 adjustable parameters. Combining the stages to form the MNEC, one finds that each output value depends on 99 input values. Thus to obtain identical results with a single stage nonlinear echo canceller would require a nonlinear function to deal with 99 input variables. An appropriate nonlinear function can be created by making a 5th power expansion in 99 variables, but this requires 91,962,520 separate adjustable parameters; this number is undesirably large compared to the 106 adjustable parameters required in the example described above.

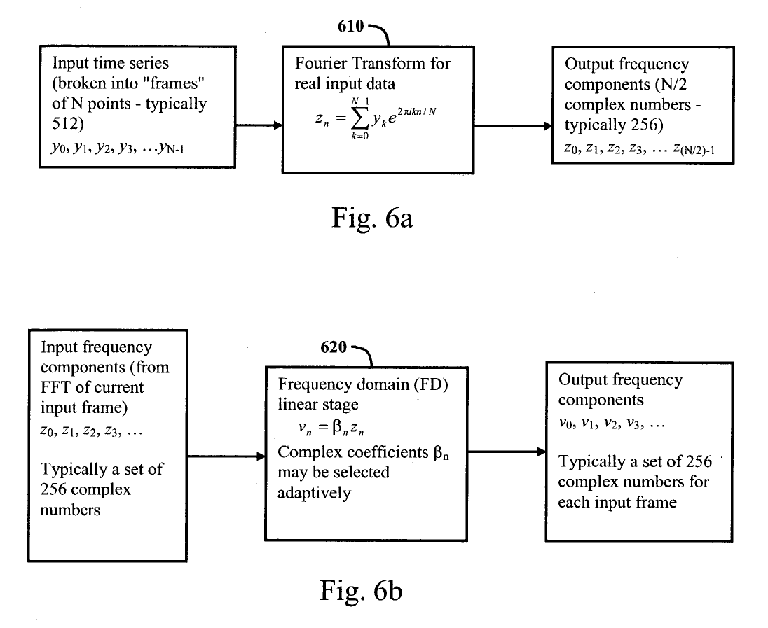

A linear stage may be implemented in the frequency domain by preceding it with a Fourier transform, such as the Fast Fourier Transform (FFT) 610 shown in FIG. 6a. In this case the linear stage is characterized by a function 620 of the form shown in FIG. 6b, which is simpler than the function 410 in FIG. 4 due to the absence of a summation. Any or all-linear stages could be implemented in this way. In that case, each linear stage would be preceded by an FFT and each would be followed by an inverse FFT. If one wished to allow the MNEC to have inputs and/or outputs in the frequency domain, then the first FFT and/or the last inverse FFT could be eliminated. This could be of value for cases where a Fourier transform is used in the demodulation process. This is true for DMT (discrete multitone) modulation that is commonly used in ADSL (asymmetric digital subscriber line) communication systems. In some cases the number of coefficients required in the frequency domain (two for each channel of a DMT signal) may be an undesirably large number to optimize. If so, the number may be reduced by making the assumption that the sequence of these parameters lies on one or more smooth curves. These curves can then be characterized by a sparse set of marker points that will be used for the optimization. The full set of parameters can be obtained from them using a cubic spline or other interpolation technique.

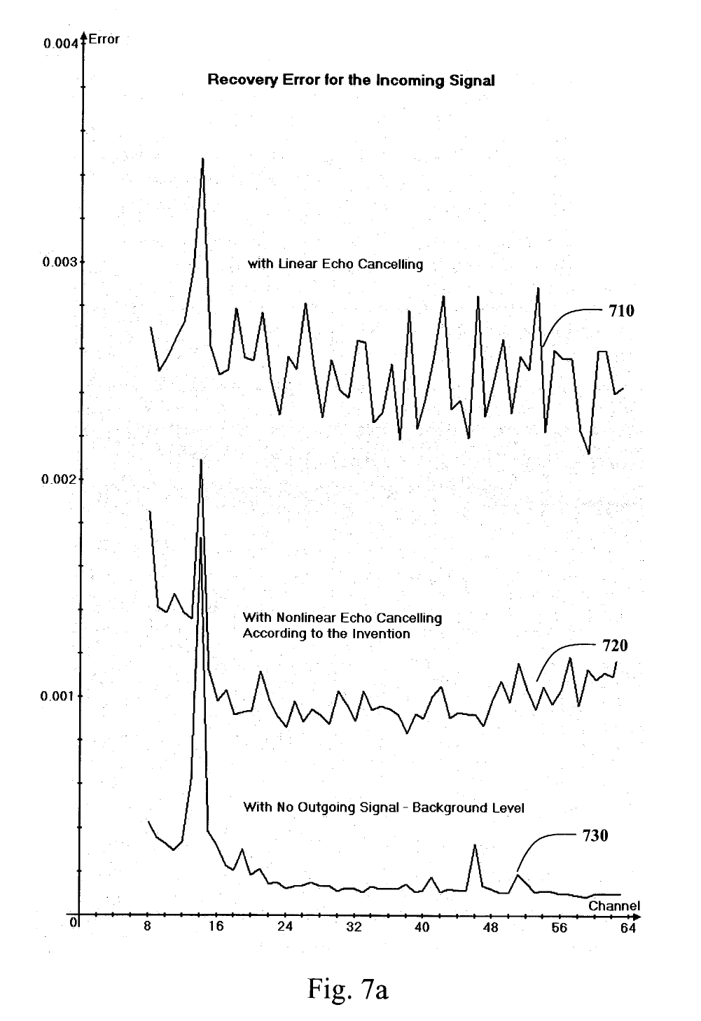

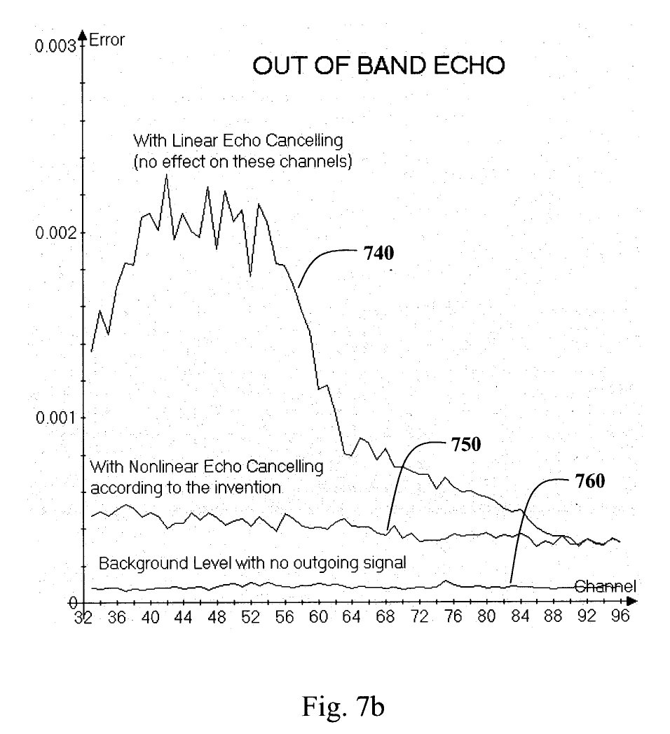

FIG. 7a presents an example of what can be accomplished with the MNEC of this invention. The system of FIG. 2 was implemented partially in hardware and partially in software. A standard DMT (discrete multitone) signal modulated with known data was transmitted through an actual 12,000-foot long twisted pair line and its echo was received for processing at the same (transmission) end. Possible sources of nonlinear distortion include, but are not limited to, the line driver (part of the hybrid) and the line coupling transformer. The graph shows the residual noise level on a linear scale as a function of the DMT channel number, with the channels spaced by about 4 kHz. The upper curve 710 shows the best result that could be achieved by linear echo canceling. The middle curve 720 shows the improvement achieved by an MNEC according to the invention, which used a similar level of complexity to the linear echo canceller results 710. Noise is reduced by over a factor of two, probably about 8 dB. The lower curve 730 shows the background level when no signal is being transmitted. The spike near channel 14 is an unidentified noise source that is part of the background.

FIG. 7b shows experimental results for the case where separate upstream and downstream bands are used, and where there is a significant out of band echo due to the nonlinear effects. The transmitted signal (upstream band) is restricted to channels 6 through 31 (not shown). The displayed channels all lie in the downstream band. If no nonlinearity was present, there would be no upstream echo in these channels. Instead, however, we see a significant echo, the curve 740, which is completely unaffected by linear echo canceling. The echo, if uncorrected, will result in a corresponding error in the recovery of incoming data contained in these downstream channels. Applying an MNEC according to the invention results in the curve 750, showing a substantial improvement. This will allow the line to support a higher data rate. The lower curve 760 is the background level for no transmitted signal. The source of the nonlinear echo in this particular example is known to be a bad contact in the line.

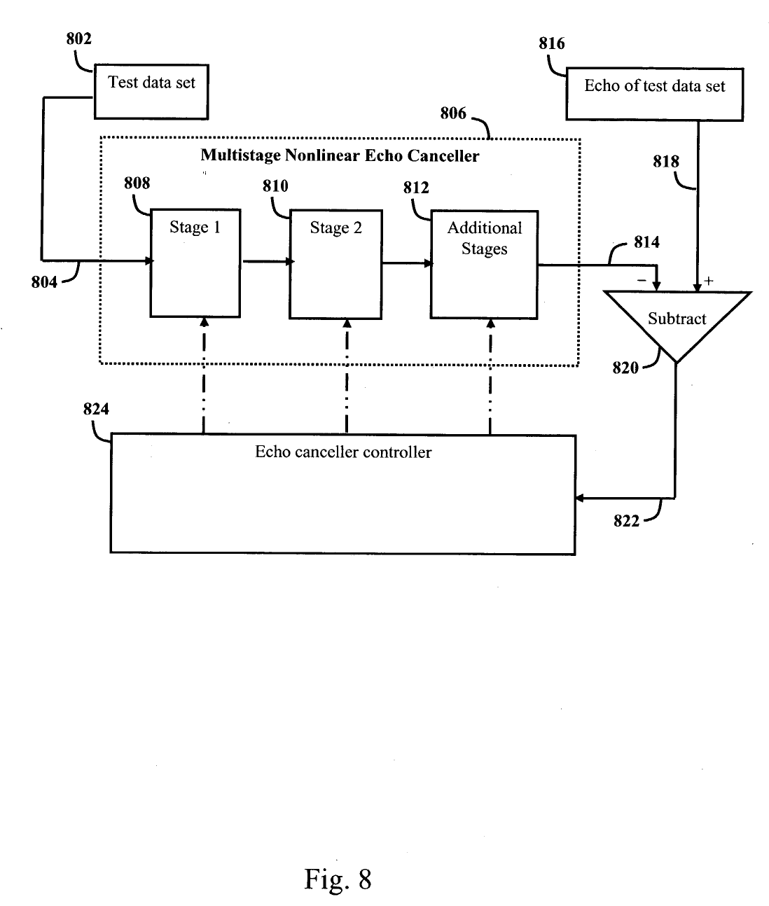

Referring now to FIG. 8, the MNEC or a copy thereof is connected in a different configuration in order to optimize its parameters. A set of testing data is generated and transmitted on the line. The echo of this signal is collected and stored. An echo canceller controller 824 is used to find the optimal parameters. It supplies a set of trial parameters to the various stages (808, 810, and 812) of the MNEC 806. Then the testing data 802 is processed by the MNEC and the result subtracted 814 from the captured echo data 816. The result is processed by the controller 824 to use in its refinement process for the parameter values.

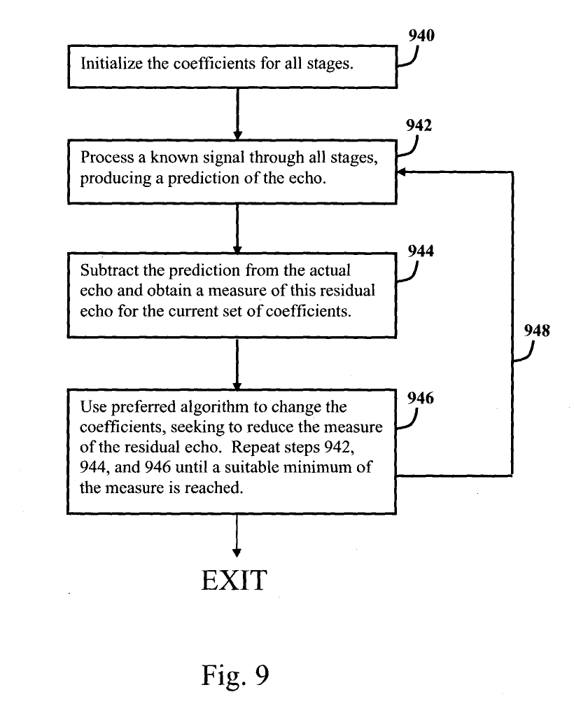

FIG. 9 shows as a series of steps how an MNEC according to this invention might be initially configured for operation. Since it utilizes optimization technology, the process of FIG. 9 may be referred to as an optimization process. The figure is a flow diagram that embodies processing performed by an echo canceller controller in response to the value of an error measure. The explanation presumes standard architecture for the various stages of the MNEC that are concretely characterized by the functions illustrated in FIGS. 4 and 5a-5f. These architectures may be implemented in any of a number of forms, including (without limitation) software routines executed by general or special purpose digital processors, programmable logic, application specific integrated circuits (ASIC), digital signal processors (DSP), and any and all equivalents. Typically, these functions are implemented in sequentially-connected arrays of storage cells in which the cells are accessed by taps in order to obtain the values stored in those cells for combination (usually multiplication) with coefficients. The values of the coefficients are stored in locations that may be accessed for the purpose of setting and changing those values.

In FIG. 9, an MNEC according to the invention is initialized in step 940. By initialization is meant that the values of all parameters for each function are set to some predetermined initial value. One choice is to initially set the parameters to values that allow the input signal to transfer to the output with little or no change. For example the linear stage of FIG. 4 could be initialized by choosing one of the parameters αₖ to set to 1 and setting all others, including the constant A, to 0. The nonlinear stage of FIG. 5a can be initialized by setting all parameters to 0. Another choice is to use as a starting point the best values for the parameters that were obtained on a previous optimization attempt. Then, in step 942, a known signal, usually containing a pseudo-random sequence of data that has been transmitted through the channel, received, and stored is processed by the MNEC. Using an error measure 944, typically the least square measure of the error generated by the subtraction (820 of FIG. 8), and a particular optimization routine (e.g. a modified Powell routine), a new set of values of the function parameters is chosen in step 946. The routine repeatedly loops at 948 through steps 942, 944, 946, each time reprocessing the stored data set through the stages with a new set of parameters, until the error measure converges to a minimum. The parameters are then fixed and can be used to model the echo for the real (unknown) data. There are many possible ways to define the error measure 944. For example, the residual signal after subtraction (820 in FIG. 8) could be processed by Fourier transform to examine how much error may remain in particular frequency channels of interest.

Modifications to the MNEC structure, such as are illustrated in FIGS. 3c and 3d require some additional steps to optimize their parameters. For the case of a parallel linear echo canceller as depicted in FIG. 3c there are at least two approaches. The first is to treat all the parameters equally and attempt to optimize all simultaneously using the method above. The second is to first set the parameters for the linear echo canceller (stage 1B in FIG. 3c) using the standard methods known in the art, while leaving the remaining stages (stages 1A, 2A, and 3A in FIG. 3c) turned off. Then all the stages could be turned on and the remaining parameters would then be optimized by the method described above while holding the parameters for the linear echo canceller fixed. For the case of the multistage combined equalizer and echo canceller (MCOM) depicted in FIG. 3d, the optimization process is a bit more complicated. Here the user would need to collect incoming data with known signals being transmitted and received simultaneously through the line. Then this received data set and the known transmitted data would be fed into the appropriate inputs of the MCOM and processed by it. The output could then be subtracted from the expected result (the known signal that was transmitted from the opposite end of the line). The difference would be used to generate an error measure that would allow an optimization routine to iteratively approach the best choice for all of the parameters of the MCOM.

There are possibly useful refinements to this optimization process. By deploying a duplicate MNEC (or MCOM), it is possible to work on optimizing a new set of parameters while simultaneously continuing to use a current set so as not to interrupt the flow of real data during this process. If a large number of parameters is involved, the optimization procedure can slow, so having this ability will prevent the occurrence of lengthy periods during which no data can be processed. In the event that there is no current set of satisfactory parameters, the preferred method would be to rapidly calculate a rough but functional set of parameters that can be used while a more highly optimized set is being calculated. Another refinement is to break the optimization process into two (or possibly more) loops. This is particularly effective if the final stage is a linear one. In this case, a full optimization can be run on the parameters in the final stage alone while holding the others fixed. Being linear, this can be accomplished very rapidly in a fast inner loop. The other parameters are adjusted by a slow outer loop using a different optimization routine. For every pass through the slow loop, the parameters in the final stage are fully optimized again by the fast loop. Note that the fast loop could be replaced by a direct calculation of the optimal parameters for the final stage using for example the technique of singular value decomposition.

Note that for nonlinear functions as may be used in this MNEC, finding the set of coefficients that produce the minimal error may produce “local minima” which are not as small as a true “global minimum”. There are well-known techniques for resolving such ambiguities. It may be necessary to start the optimization process from a variety of initial conditions or to use a somewhat slower optimization routine which is intended to find a global minimum. Some useful techniques may include, without limitation, a modified Powell method, a conjugate gradient method, multidimensional dithering and simulated annealing. These and other means and methods for optimization and minimization may be found, for example, in “Numerical Recipes: The Art of Scientific Computing with Listings in C” by William Press, et al., Cambridge University Press, 1989.

I claim:

1. In a digital transmission system, a combination for canceling an echo of a digitally-modulated signal to be transmitted through a dispersive medium from a digitally-modulated signal received from the dispersive medium, comprising:
a source of a digitally-modulated signal;
a digital-to-analog converter (DAC) with an input coupled to receive the digitally-modulated signal;
a hybrid with an input coupled to receive a digitally-modulated analog signal produced by the DAC and to provide the digitally-modulated analog signal for transmission in a dispersive channel, the hybrid having an output for providing a digitally-modulated analog signal received from the dispersive channel;
an analog-to-digital converter (ADC) coupled to receive the digitally-modulated signal received from the dispersive channel, the ADC having an output;
a multistage echo canceller having an input coupled to the source of the transmitted digitally-modulated signal and an output;
the multistage echo canceller having a first stage characterized by a first function to produce first results modeling linear distortion in an echo of the transmitted digitally-modulated signal, and at least a second stage, the second stage characterized by a second function to produce from the first results second results modeling nonlinear distortion in the echo of the transmitted digitally-modulated signal; and
a subtracter with a first input connected to the output of the multistage echo canceller, a second input connected to the output of the ADC, and an output.

2. The combination of claim 1, the multistage echo canceller comprising:
three or more stages;
each stage having an input and an output, the input of any stage following another stage in the sequence being connected to the output of the other stage;
each stage being characterized by a respective function that, in response to an input digital time series x₁, x₂, x₃, . . . , produces an output digital time series y₁, y₂, y₃, . . . , the value of any element of the output time series depending on the values of one or more of the elements of the input series; and
the sequence causing the stages to alternate in their respective functions between linear functions and nonlinear functions.

3. The combination of claim 2, wherein the sequence continues with one or more stages following the third stage, the respective functions of the one or more stages alternating in the sequence (nonlinear, linear, nonlinear, . . . ).

4. The combination of claim 2, in which the linear functions include the function:
$${x}_{n} = A + {\sum }_{k = {k}_{0}}^{{k}_{1}} {α}_{k} {u}_{n + k}$$
where A is a constant and αₖ is a parameter of the function, the parameter having a settable value.

5. The combination of claim 2 in which one or more of the nonlinear functions are functions in the group including: a one-dimensional power series function; an inverse of a known non-linear function; an inverse of a known piecewise linear function; a one-dimensional, difference-based power series function of degree P; a one-dimensional function depending on k parameters; a two-dimensional power series of degree P; and, a D-dimensional function, depending on k parameters.

6. A transmit/receive apparatus for a digital modulation transmission system, comprising:
a digital-to-analog converter (DAC) with an input coupled to receive a digitally-modulated signal;
a filter coupled to the DAC for filtering a digitally-modulated analog signal produced by the DAC;
a hybrid coupled to the filter for providing the digitally-modulated analog signal produced by the DAC and filtered by the filter to a dispersive channel for transmission therein, and for receiving a digitally-modulated analog signal from the dispersive channel;
an analog-to-digital converter (ADC) coupled to receive the digitally-modulated analog signal received from the dispersive channel, the ADC having an output for providing a converted digitally-modulated signal;
a multistage echo canceller having an input coupled to the source of a digitally-modulated signal and an output;
the multistage echo canceller having a first stage characterized by a first function to produce first results modeling first linear distortion in an echo of the digitally-modulated signal, a second stage coupled in series with the first stage, the second stage characterized by a second function to produce from the first results second results modeling nonlinear distortion in the echo of the digitally-modulated signal, and at least a third stage, the third stage characterized by a third function to produce from the second results third results modeling second linear distortion in the echo of the digitally-modulated signal; and
a subtracter coupled to the output of the ADC and to the output of the multistage echo canceller for subtracting the modeled echo of the transmitted digitally-modulated signal, corrected for linear and non-linear distortion, from the converted received digitally-modulated signal.

7. The transmit/receive apparatus of claim 6, the multistage echo canceller comprising:
three or more stages connected in a sequence;
each stage having an input and an output, the input of any stage following another stage in the sequence being connected to the output of the other stage;
each stage being characterized by a respective function that, in response to an input digital time series x₁, x₂, x₃, . . . , produces an output digital time series y₁, y₂, y₃, . . . , the value of any element of the output time series depending on the values of one or more of the elements of the input series; and
the sequence causing the stages to alternate in their respective functions between linear functions and nonlinear functions.

8. The transmit/receive apparatus of claim 7, wherein the sequence continues with one or more stages following the third stage, the respective functions of the one or more stages alternating in the sequence (nonlinear, linear, nonlinear, . . . ).

9. The transmit/receive apparatus of claim 6, in which the linear functions include the function:
$${x}_{n} = A + {\sum }_{k = {k}_{0}}^{{k}_{1}} {α}_{k} {u}_{n + k}$$
where A is a constant and αₖ is a parameter of the function, the parameter having a settable value.

10. The transmit/receive apparatus of claim 6 in which one or more of the nonlinear functions are functions in the group including: a one-dimensional power series function; an inverse of a known non-linear function; an inverse of a known piecewise linear function; a one-dimensional, difference-based power series function of degree P; a one-dimensional function depending on k parameters; a two-dimensional power series of degree P; and, a D-dimensional function, depending on k parameters.

11. In a digital transmission system, a method for modeling and canceling the echo of a digitally-modulated signal to be transmitted through a dispersive medium from a digitally-modulated signal received from the dispersive medium, comprising:
providing a first digitally-modulated signal;
converting the first digitally-modulated signal to a first digitally modulated analog signal;
providing the first digitally-modulated analog signal to a hybrid for transmission through a dispersive channel;
providing from the hybrid a second digitally-modulated analog signal received from the dispersive channel having an echo of the first digitally modulated analog signal;
converting the second digitally-modulated analog signal to a second digitally-modulated signal;
modeling a distorted echo of the first digitally modulated signal;
producing a corrected echo of the first digitally-modulated signal by correcting the model of the distorted echo of the first digitally-modulated signal for linear distortion using a first function, at least followed by correcting the model of the echo of the first digitally-modulated signal using a second function for nonlinear distortion; and
subtracting the corrected echo from the second digitally-modulated signal.

12. The method of claim 11, wherein producing a corrected echo signal includes:
correcting the model of the distorted echo of the first digitally-modulated signal in a sequence of functions;
each function having an input and an output, the input of any function following another function in the sequence receiving the output of the other function;
each function being characterized by a response to an input digital time series x₁, x₂, x₃, . . . , that produces an output digital time series y₁, y₂, y₃, . . . , the value of any element of the output time series depending on the values of one or more of the elements of the input series; and
the sequence causing the functions to alternate between linear functions and nonlinear functions.

13. The method of claim 12, in which the linear functions include the function:
$${x}_{n} = A + {\sum }_{k = {k}_{0}}^{{k}_{1}} {α}_{k} {u}_{n + k}$$
where A is a constant and αₖ is a parameter of the function, the parameter having a settable value.

14. The method of claim 12 in which one or more of the nonlinear functions are functions in the group including: a one-dimensional power series function; an inverse of a known non-linear function; an inverse of a known piecewise linear function; a one-dimensional, difference-based power series function of degree P; a one-dimensional function depending on k parameters; a two-dimensional power series of degree P; and, a D-dimensional function, depending on k parameters.

15. An echo cancellation method for a transmitter/receiver, comprising:
converting a first digitally-modulated signal to analog form;
filtering the analog form of the first digitally-modulated signal;
coupling the filtered analog form of the first digitally-modulated signal to an end of a dispersive channel for transmission therein;
receiving a second digitally-modulated analog signal from the end of the dispersive channel;
converting the second digitally-modulated analog signal to a second digitally-modulated signal;
modeling a distorted echo of the first digitally modulated signal;
producing a corrected echo by using a first function to produce first results correcting first linear distortion in the model of the distorted echo of the first digitally-modulated signal, using a second function to produce from the first results second results correcting nonlinear distortion in the model of the distorted echo of the first digitally-modulated signal, and using at least a third function to produce third results from the second results correcting second linear distortion in the model of the distorted echo of the first digitally-modulated signal; and subtracting the corrected echo from the second digitally-modulated signal.

16. The method of claim 15, wherein producing a corrected echo includes:
correcting the model of the distorted echo of the first digitally-modulated signal in a sequence of functions;
each function having an input and an output, the input of any function following another function in the sequence receiving the output of the other function;
each function being characterized by a response to an input digital time series x₁, x₂, x₃, . . . , that produces an output digital time series y₁, y₂, y₃, . . . , the value of any element of the output time series depending on the values of one or more of the elements of the input series; and
the sequence causing the functions to alternate between linear functions and nonlinear functions.

17. The method of claim 16, wherein the sequence continues with one or more functions following the third function, the one or more functions alternating in the sequence (nonlinear, linear, nonlinear, . . . ).

18. The method of claim 16, in which the linear functions include the function:
$${x}_{n} = A + {\sum }_{k = {k}_{0}}^{{k}_{1}} {α}_{k} {u}_{n + k}$$
where A is a constant and αₖ is a parameter of the function, the parameter having a settable value.

19. The method of claim 16, in which one or more of the nonlinear functions are functions in the group including: a one-dimensional power series function; an inverse of a known non-linear function; an inverse of a known piecewise linear function; a one-dimensional, difference-based power series function of degree P; a one-dimensional function depending on k parameters; a two-dimensional power series of degree P; and, a D-dimensional function, depending on k parameters.

20. A transmit/receive apparatus for a digital subscriber line (DSL) system, comprising:
a digital-to-analog converter (DAC) with an input coupled to receive a digitally-modulated signal;
a filter coupled to the DAC for filtering a digitally-modulated analog signal produced by the DAC;
a hybrid coupled to the filter for providing the digitally-modulated analog signal produced by the DAC and filtered by the filter to a DSL channel for transmission therein, and for receiving a digitally-modulated analog signal from the DSL channel;
an analog-to-digital converter (ADC) coupled to receive the digitally-modulated analog signal received from the DSL channel, the ADC having an output for providing a converted digitally-modulated signal;
a multistage echo canceller having an input coupled to the source of a digitally-modulated signal and an output;
the multistage echo canceller having a first stage characterized by a first function to produce first results modeling first linear distortion in an echo of the digitally-modulated signal, a second stage coupled in series with the first stage, the second stage characterized by a second function to produce from the first results second results modeling nonlinear distortion in the echo of the digitally-modulated signal, and at least a third stage, the third stage characterized by a third function to produce from the second results third results modeling second linear distortion in the echo of the digitally-modulated signal; and
a subtracter coupled to the output of the ADC and to the output of the multistage echo canceller for subtracting the modeled echo of the transmitted digitally-modulated signal, corrected for linear and non-linear distortion, from the converted received digitally-modulated signal.

21. The transmit/receive apparatus of claim 20, the multistage echo canceller comprising:
three or more stages connected in a sequence;
each stage having an input and an output, the input of any stage following another stage in the sequence being connected to the output of the other stage;
each stage being characterized by a respective function that, in response to an input digital time series x₁, x₂, x₃, . . . , produces an output digital time series y₁, y₂, y₃, . . . , the value of any element of the output time series depending on the values of one or more of the elements of the input series; and
the sequence causing the stages to alternate in their respective functions between linear functions and nonlinear functions.

22. The transmit/receive apparatus of claim 21, wherein the sequence continues with one or more stages following the third stage, the respective functions of the one or more stages alternating in the sequence (nonlinear, linear, nonlinear, . . . ).

23. The transmit/receive apparatus of claim 21, in which the linear functions include the function:
$${x}_{n} = A + {\sum }_{k = {k}_{0}}^{{k}_{1}} {α}_{k} {u}_{n + k}$$
where A is a constant and αₖ is a parameter of the function, the parameter having a settable value.

24. The transmit/receive apparatus of claim 21 in which one or more of the nonlinear functions are functions in the group including: a one-dimensional power series function; an inverse of a known non-linear function; an inverse of a known piecewise linear function; a one-dimensional, difference-based power series function of degree P; a one-dimensional function depending on k parameters; a two-dimensional power series of degree P; and, a D-dimensional function, depending on k parameters.

25. An echo cancellation method for a transmitter/receiver in a digital subscriber line (DSL) system, comprising:
converting a first digitally-modulated signal to analog form;
filtering the analog form of the first digitally-modulated signal;
coupling the filtered analog form of the first digitally-modulated signal to an end of a DSL channel for transmission therein;
receiving a second digitally-modulated analog signal from the end of the DSL channel;
converting the second digitally-modulated analog signal to a second digitally-modulated signal;
modeling a distorted echo of the first digitally modulated signal;
producing a corrected echo by using a first function to produce first results correcting first linear distortion in the model of the distorted echo of the first digitally-modulated signal, using a second function to produce from the first results second results correcting nonlinear distortion in the model of the distorted echo of the first digitally-modulated signal, and using at least a third function to produce third results from the second results correcting second linear distortion in the model of the distorted echo of the first digitally-modulated signal; and
subtracting the corrected echo from the second digitally-modulated signal.

26. The method of claim 25, wherein producing a corrected echo includes:
correcting the model of the distorted echo of the first digitally-modulated signal in a sequence of functions;
each function having an input and an output, the input of any function following another function in the sequence receiving the output of the other function;
each function being characterized by a response to an input digital time series x₁, x₂, x₃, . . . , that produces an output digital time series y₁, y₂, y₃, . . . , the value of any element of the output time series depending on the values of one or more of the elements of the input series; and
the sequence causing the functions to alternate between linear functions and nonlinear functions.

27. The method of claim 26, wherein the sequence continues with one or more functions following the third function, the one or more functions alternating in the sequence (nonlinear, linear, nonlinear, . . . ).

28. The method of claim 26, in which the linear functions include the function:
$${x}_{n} = A + {\sum }_{k = {k}_{0}}^{{k}_{1}} {α}_{k} {u}_{n + k}$$
where A is a constant and αₖ is a parameter of the function, the parameter having a settable value.

29. The method of claim 26, in which one or more of the nonlinear functions are functions in the group including: a one-dimensional power series function; an inverse of a known non-linear function; an inverse of a known piecewise linear function; a one-dimensional, difference-based power series function of degree P; a one-dimensional function depending on k parameters; a two-dimensional power series of degree P; and, a D-dimensional function, depending on k parameters.

30. In a digital transmission system, a combination for canceling an echo of a digitally-modulated signal to be transmitted through a dispersive medium from a digitally-modulated signal received from the dispersive medium, comprising:
a source of a digitally-modulated signal;
a digital-to-analog converter (DAC) with an input coupled to receive the digitally-modulated signal;
a hybrid with an input coupled to receive a digitally-modulated analog signal produced by the DAC and to provide the digitally-modulated analog signal for transmission in a dispersive channel, the hybrid having an output for providing a digitally-modulated analog signal received from the dispersive channel;
an analog-to-digital converter (ADC) coupled to receive the digitally-modulated signal received from the dispersive channel, the ADC having an output;
a multistage echo canceller having an input coupled to the source of the transmitted digitally-modulated signal and an output;
the multistage echo canceller having a plurality of stages connected in a sequence, the plurality of stages including first stage characterized by a first function to produce first results modeling distortion in an echo of the transmitted digitally-modulated signal, and at least a second stage, the second stage characterized by a second function to produce from the first results second results modeling distortion in the echo of the transmitted digitally-modulated signal;
the sequence including at least one linear stage and one nonlinear stage; and
a subtracter with a first input connected to the output of the multistage echo canceller, a second input connected to the output of the ADC, and an output.

31. The combination of claim 30, the multistage echo canceller comprising:
three or more stages;
each stage having an input and an output, the input of any stage following another stage in the sequence being connected to the output of the other stage; and
each stage being characterized by a respective function that, in response to an input digital time series x₁, x₂, x₃, . . . , produces an output digital time series y₁, y₂, y₃, . . . , the value of any element of the output time series depending on the values of one or more of the elements of the input series.

32. The combination of claim 31, wherein the sequence continues with one or more stages following the third stage, the respective functions of the one or more stages alternating in the sequence (nonlinear, linear, nonlinear, . . . ).

33. The combination of claim 31, in which the linear functions include the function:
$${x}_{n} = A + {\sum }_{k = {k}_{0}}^{{k}_{1}} {α}_{k} {u}_{n + k}$$
where A is a constant and αₖ is a parameter of the function, the parameter having a settable value.

34. The combination of claim 31, in which one or more of the nonlinear functions are functions in the group including: a one-dimensional power series function; an inverse of a known non-linear function; an inverse of a known piecewise linear function; a one-dimensional, difference-based power series function of degree P; a one-dimensional function depending on k parameters; a two-dimensional power series of degree P; and, a D-dimensional function, depending on k parameters.

35. The combination of claim 31, in which one or more of the linear functions are implemented in the frequency domain.

36. The combination of claim 30, further including:
a linear echo canceller having an input connected in common with an input of one of the stages, and an output; and
an adder having a first input connected to the output of the linear echo canceller and having a second input connected to the output of one stage of the plurality of stages, the adder for providing a combined output as an input to another stage of the plurality of stages, or as the output of the multistage echo canceller.

37. The combination of claim 36, wherein:
the plurality of stages further includes a last stage;
the input of the linear echo canceller is connected in common with the input of the first stage; and
the output of the linear echo canceller is connected to the first input of the adder and the output of the last stage is connected to the second input of the adder.

38. The combination of claim 36, wherein:
the multistage echo canceller comprises three or more stages in a sequence and the linear echo canceller comprises a single stage;
each stage having an input and an output; and
each stage being characterized by a respective function that, in response to an input digital time series x₁, x₂, x₃, . . . , produces an output digital time series y₁, y₂, y₃, . . . , the value of any element of the output time series depending on the values of one or more of the elements of the input series

39. The combination of claim 38, in which the linear functions include the function:
$${x}_{n} = A + {\sum }_{k = {k}_{0}}^{{k}_{1}} {α}_{k} {u}_{n + k}$$
where A is a constant and αₖ is a parameter of the function, the parameter having a settable value.

40. The combination of claim 38, in which one or more of the nonlinear functions are functions in the group including: a one-dimensional power series function; an inverse of a known non-linear function; an inverse of a known piecewise linear function; a one-dimensional, difference-based power series function of degree P; a one-dimensional function depending on k parameters; a two-dimensional power series of degree P; and, a D-dimensional function, depending on k parameters.

41. The combination of claim 38 in which one or more of the linear functions are implemented in the frequency domain.

42. In a digital transmission system, an apparatus for canceling an echo of a digitally-modulated signal to be transmitted through a dispersive medium from a digitally-modulated signal received from the dispersive medium, and for removing effects of nonlinear coupling between the transmitted and received signals and for equalizing the received signal, the apparatus comprising:
a source of a digitally-modulated signal;
a digital-to-analog converter (DAC) with an input coupled to receive the digitally-modulated signal;
a hybrid with an input coupled to receive a digitally-modulated analog signal produced by the DAC and to provide the digitally-modulated analog signal for transmission in a dispersive channel, the hybrid having an output for providing a digitally-modulated analog signal received from the dispersive channel;
an analog-to-digital converter (ADC) coupled to receive the digitally-modulated signal received from the dispersive channel, the ADC having an output;
a multistage combination having a first input coupled to the source of the transmitted digitally-modulated signal and a second input coupled to the output of the ADC and an output;
the multistage combination having a first sequence of zero or more stages having an output and an input connected to the first input, a second sequence of zero or more stages having an output and an input connected to the second input, a coupling stage having two inputs and one output, the first input connected to the output of the first sequence, the second input connected to the output of the second sequence, and a third sequence of zero or more stages having an output and an input, the input of the third sequence connected to the output of the coupling stage; and
the first sequence for producing first results modeling distortion in the transmitted signal, the second sequence for producing second results correcting distortion in the received signal, the coupling stage for producing third results correcting coupling between transmitted and received signals and canceling echo, and the third sequence for producing fourth results correcting distortion in the received signal;
the multistage combination including at least one nonlinear stage.

43. The apparatus of claim 42, wherein the first, second, and final sequences each includes a single linear stage, each linear stage having an input and an output, each linear stage being characterized by a respective function that, in response to an input digital time series x₁, x₂, x₃, . . . , produces an output digital time series y₁, y₂, y₃, . . . , the value of any element of the output time series depending on the values of one or more of the elements of the input series, and the coupling stage being characterized by a function that, in response to input digital time series x₁, x₂, x₃, . . . and y₁, y₂, y₃, . . . , produces an output digital time series z₁, z₂, z₃, K, the value of any element of the output time series produced by the coupling stage depending on the values of one or more of the elements of each of the input series.

44. The apparatus of claim 43, in which the linear functions include the function:
$${x}_{n} = A + {\sum }_{k = {k}_{0}}^{{k}_{1}} {α}_{k} {u}_{n + k}$$
where A is a constant and αₖ is a parameter of the function, the parameter having a settable value.

45. The apparatus of claim 43, wherein the coupling stage is characterized by a nonlinear function from the group including: a two-dimensional power series function depending on one element from each input; a two-dimensional function depending on k parameters and on one element from each of the two inputs; and, a D-dimensional function, depending on k parameters and on A elements from the first input and on B elements from the second input, where A+B=D.

46. The apparatus of claim 43 in which one or more of the linear functions are implemented in the frequency domain.
